(19) United States
(12) Patent Application Publication
(10) Pub. No.: US 2007/0214025 A1
(43) Pub. Date: Sep. 13, 2007

(54) Business engagement management

(75) Inventors: Yunhee Jang, Poughkeepsie, NY (US); Juhnyoung Lee, Yorktown Heights, NY (US); Grace Y. Lin, Chappaqua, NY (US); Qingying Lu, Oakton, VA (US); David D. Yao, Yorktown Heights, NY (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/373,948

(22) Filed: Mar. 13, 2006

(51) Int. Cl. G06F 9/44

(52) U.S. Cl. 705/7

(57) ABSTRACT

A solution for managing a business engagement between a provider and a client is provided. The business engagement includes one or more business solutions for which a client risk preference level is obtained. One of a plurality of engagement types is also obtained for the business solution(s) based on a business goal for the business solution(s). A pricing model for each business solution is then selected based on the engagement type and the client risk preference level. Further, the pricing model can be selected based on additional factors, such as a provider risk preference level, a business value for the business solution, and/or the like. The pricing model can comprise a risk/gain sharing pricing model having a fixed price and/or variable price pricing structure. Performance data for the business solution can be obtained and used as feedback for future business engagements and/or to implement the risk/gain sharing pricing model.

### REFERENCE TO RELATED APPLICATION

The current application is related to co-owned and co-pending U.S. patent application Ser. No. 11/200,847, filed on Aug. 10, 2005, and entitled “Business Solution Evaluation”, co-owned and co-pending U.S. patent application Ser. No. 11/200,727, filed on Aug. 10, 2005, and entitled “Value Model” and co-owned and co-pending U.S. patent application Ser. No. 11/295,828, filed on Dec. 7, 2005, and entitled “Business Solution Management”, each of which is hereby incorporated herein by reference.

### FIELD OF THE INVENTION

The invention relates generally to managing a business engagement, and more particularly, to a solution for selecting and/or implementing a pricing model for a business solution included in the business engagement.

### BACKGROUND OF THE INVENTION

To date, most engagement contracts for business solutions, such as services, product purchases, and/or the like, are based on a “fixed price” pricing model. Using the fixed price pricing model, a provider may determine the price for providing a particular service/good by determining the cost to provide the service/good and adding a certain profit. For example, a service provider may charge $1,100 for a service that costs $1,000 to provide in order to make a ten percent profit. Another pricing model comprises a “venturing” pricing model. Using the venturing pricing model, a provider is given equity in a client as payment, the provider and client form a joint venture, and/or the like, in return for the goods/services provided to the client.

Under the fixed price pricing model, the client and provider have dissimilar goals with respect to the business solution. In particular, the client has a goal of improving some aspect of its business (e.g., the reward), but has no direct financial interest in the efficiency with which the business solution is provided (e.g., the risk). In contrast, the provider has a risk-based goal of providing the business solution efficiently, but has no direct financial interest in the reward-based improvement to the client's business. Under the venturing pricing model, both the client and provider have a direct financial interest in both the risk-based efficiency with which the business solution is provided and the reward-based improvement to some aspect of the business.

Frequently, a client and provider seek to more closely align their goals by sharing some of the risks/rewards for a particular business solution. However, due to the resulting shared ownership, a venturing pricing model often is not desired by one or both parties. In these cases, the parties may seek to manage a business engagement using a pricing model that incorporates some aspects of both the fixed price pricing model and the venturing pricing model. To date, such a pricing model is negotiated by the parties for each business solution entered into by the parties.

In view of the foregoing, there exists a need in the art to overcome one or more of the deficiencies indicated herein.

### SUMMARY OF THE INVENTION

The invention provides a solution for managing a business engagement between a provider and a client. The business engagement includes one or more business solutions for which a client risk preference level is obtained. One of a plurality of engagement types is also obtained for the business solution based on a business goal for the business solution. A pricing model for the business solution is then selected based on the engagement type and the client risk preference level. Further, the pricing model can be selected based on additional factors, such as a provider risk preference level, a business value for the business solution, and/or the like. The pricing model can comprise a risk/gain sharing pricing model having a fixed price and/or variable price pricing structure. Performance data for the business solution can be obtained and used as feedback for future business engagements and/or to implement the risk/gain sharing pricing model. In this manner, the invention provides an improved solution for managing a business engagement throughout its lifecycle.

A first aspect of the invention provides a method of managing a business engagement between a provider and a client, the method comprising: obtaining a business solution included in the business engagement; obtaining a client risk preference level for the business solution; obtaining one of a plurality of engagement types for the business solution based on a business goal for the business solution; and selecting one of a plurality of pricing models for the business solution based on the engagement type and the client risk preference level.

A second aspect of the invention provides a system for managing a business engagement between a provider and a client, the system comprising: a system for obtaining a business solution included in the business engagement; a system for obtaining a client risk preference level for the business solution; a system for obtaining one of a plurality of engagement types for the business solution based on a business goal for the business solution; and a system for selecting one of a plurality of pricing models for the business solution based on the engagement type and the client risk preference level.

A third aspect of the invention provides a program product stored on a computer-readable medium, which when executed, enables a computer infrastructure to manage a business engagement between a provider and a client, the program product comprising computer program code for enabling the computer infrastructure to: obtain a business solution included in the business engagement; obtain a client risk preference level for the business solution; obtain one of a plurality of engagement types for the business solution based on a business goal for the business solution; and select one of a plurality of pricing models for the business solution based on the engagement type and the client risk preference level.

A fourth aspect of the invention provides a method of generating a system for managing a business engagement between a provider and a client, the method comprising: providing a computer infrastructure operable to: obtain a business solution included in the business engagement; obtain a client risk preference level for the business solution; obtain one of a plurality of engagement types for the business solution based on a business goal for the business solution; and select one of a plurality of pricing models for the business solution based on the engagement type and the client risk preference level.

A fifth aspect of the invention provides a business method for managing a business engagement between a provider and a client, the business method comprising managing a computer infrastructure that performs the process described herein; and receiving payment based on the managing.

The illustrative aspects of the present invention are designed to solve one or more of the problems herein described and/or one or more other problems not discussed.

### BRIEF DESCRIPTION OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for managing a business engagement between a provider and a client according to an embodiment of the invention.

FIG. 2 shows an illustrative process that can be implemented by the environment of FIG. 1 according to an embodiment of the invention.

FIG. 3 shows an illustrative component business map according to an embodiment of the invention.

FIG. 4 shows a graph of an illustrative set of pricing models that shows the relative benefit level versus financial risk/reward for each pricing model.

FIG. 5 shows an illustrative value-based pricing structure.

FIG. 6 shows an illustrative value model according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the invention provides a solution for managing a business engagement between a provider and a client. The business engagement includes one or more business solutions for which a client risk preference level is obtained. One of a plurality of engagement types is also obtained for the business solution based on a business goal for the business solution. A pricing model for the business solution is then selected based on the engagement type and the client risk preference level. Further, the pricing model can be selected based on additional factors, such as a provider risk preference level, a business value for the business solution, and/or the like. The pricing model can comprise a risk/gain sharing pricing model having a fixed price and/or variable price pricing structure. Performance data for the business solution can be obtained and used as feedback for future business engagements and/or to implement the risk/gain sharing pricing model. In this manner, the invention provides an improved solution for managing a business engagement throughout its lifecycle. As used herein, unless otherwise noted, the term “set” means one or more (i.e., at least one).

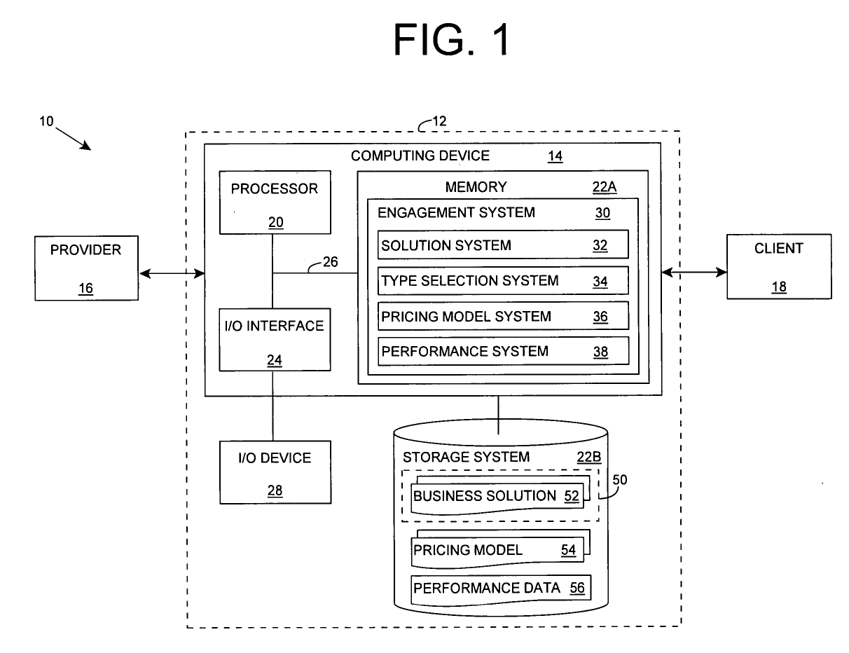

Turning to the drawings, FIG. 1 shows an illustrative environment 10 for managing a business engagement 50 between a provider 16 and a client 18 according to an embodiment of the invention. To this extent, environment 10 includes a computer infrastructure 12 that can perform the process described herein in order to manage business engagement 50. In particular, computer infrastructure 12 is shown including a computing device 14 that comprises an engagement system 30, which makes computing device 14 operable to manage business engagement 50 by performing the process described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as engagement system 30, which is stored in memory 22A and/or storage system 22B. While executing computer program code, processor 20 can read and/or write data, such as business solution 52, to/from memory 22A, storage system 22B, and/or I/O interface 24. Bus 26 provides a communications link between each of the components in computing device 14. I/O device 28 can comprise any device that enables an individual to interact with computing device 14 or any device that enables computing device 14 to communicate with one or more other computing devices using any type of communications link.

In any event, computing device 14 can comprise any general purpose computing article of manufacture capable of executing computer program code installed thereon (e.g., a personal computer, server, handheld device, etc.). However, it is understood that computing device 14 and engagement system 30 are only representative of various possible equivalent computing devices that may perform the process described herein. To this extent, in other embodiments, the functionality provided by computing device 14 and engagement system 30 can be implemented by a computing article of manufacture that includes any combination of general and/or specific purpose hardware and/or computer program code. In each embodiment, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of communications link, such as a network, a shared memory, or the like, to perform the process described herein. Further, while performing the process described herein, one or more computing devices in computer infrastructure 12 can communicate with one or more other computing devices external to computer infrastructure 12 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols.

As discussed herein, engagement system 30 enables computer infrastructure 12 to manage a business engagement 50. To this extent, engagement system 30 is shown including an solution system 32, a type selection system 34, a pricing model system 36, and a performance system 38. Operation of each of these systems is discussed further herein. However, it is understood that some of the various systems shown in FIG. 1 can be implemented independently, combined, and/or stored in memory for one or more separate computing devices that are included in computer infrastructure 12. Further, it is understood that some of the systems and/or functionality may not be implemented, or additional systems and/or functionality may be included as part of computer infrastructure 12.

Regardless, the invention provides a solution for managing business engagement 50 between provider 16 and client 18. In general, business engagement 50 includes a set of business solutions 52, each of which will be provided by provider 16 (or a related entity) to client 18 as part of business engagement 50. Each business solution 52 can comprise goods (e.g., a new product purchase), services (e.g., information technology management), or some combination thereof.

Engagement system 30 can manage business engagement 50 throughout the evaluation, proposal, contractual, delivery, and performance lifecycles of business engagement 50. To this extent, it is understood that business engagement 50 may be at any of the various stages in the lifecycle, and business engagement 50 may or may not result in a contractual agreement and performance by provider 16. Further, business engagement 50 can include additional data, such as an identification of provider 16 and/or client 18, a status of the engagement, and/or the like. Still further, it is understood that engagement system 30 can be utilized by provider 16, client 18, and/or a third party user to manage business engagement 50.

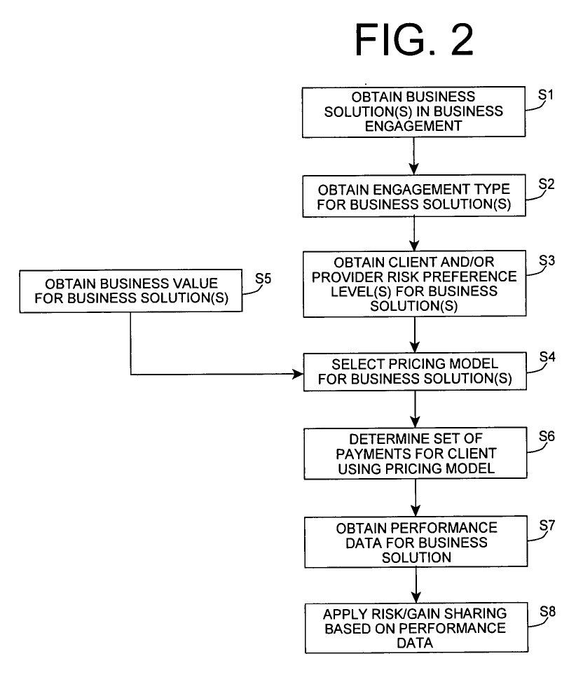

FIG. 2 shows an illustrative process that can be implemented by environment 10 (FIG. 1) according to an embodiment of the invention. Referring to FIGS. 1 and 2, in step S1, solution system 32 obtains each business solution 52 included in business engagement 50. Solution system 32 can obtain each business solution 52 using any known solution. For example, a user, such as provider 16 and/or client 18, can identify, define, and/or provide business solution(s) 52 to solution system 32. In one embodiment, the user comprises an individual, and solution system 32 generates a user interface for presentation to the user, which enables the user to identify, define, modify, view, delete, and/or the like each business solution 52. In this case, solution system 32 can provide the user interface for presentation to the user on an I/O device 28 and/or over a network such as the Internet. Alternatively, the user can comprise another system and solution system 32 can support an Application Program Interface (API) or the like that enables the user to perform the various operations with respect to business solution(s) 52.

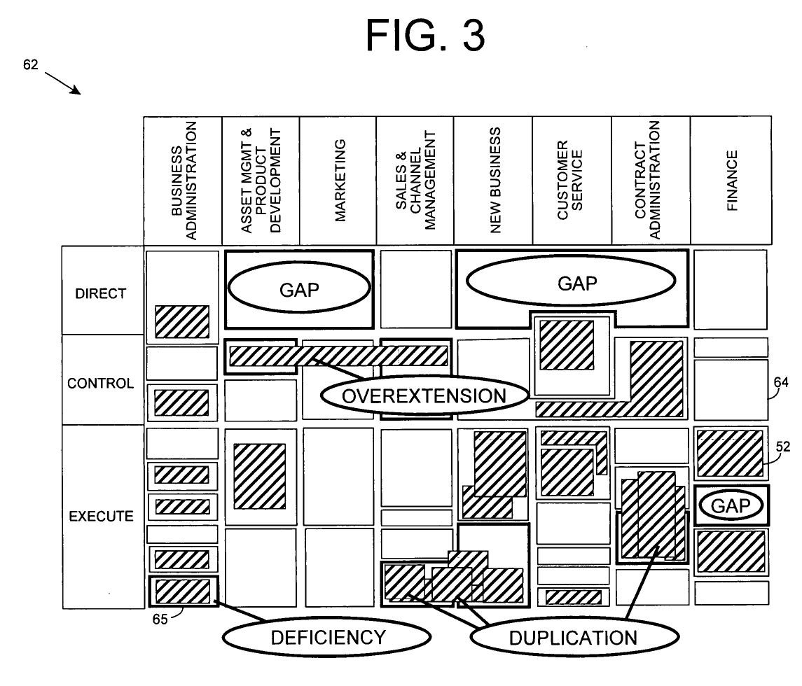

In one embodiment, solution system 32 comprises a similar system as that disclosed in the co-owned and co-pending U.S. patent application Ser. No. 11/295,828, filed on Dec. 7, 2005, and entitled “Business Solution Management”, which was previously incorporated herein by reference. In this case, solution system 32 can obtain business solution(s) 52 by obtaining a set of business pain points and/or a set of resource constraint(s) for client 18 and obtain a set of business components based on the set of business pain points. To this extent, solution system 32 can use a component business map for client 18. FIG. 3 shows an illustrative component business map 62 according to an embodiment of the invention. In general, component business map 62 includes various business components, such as business component 64, with their corresponding business solutions, such as business solution 52. Solution system 32 can identify each business component 64 associated with a particular business pain point, and can indicate the business component(s) 64 in component business map 62 as “hot” business components, such as business component 65.

Solution system 32 (FIG. 1) can use component business map 62 to identify and/or categorize a set of shortfalls that are responsible for the business pain point(s). For example, component business map 62 is shown having several shortfalls identified. In general, shortfalls can be classified in one of several categories: a “gap” shortfall is present when there is no business solution 52 for a particular “hot” business component 64; a “deficiency” shortfall is present when the capability of the business solution 52 is not addressing all of the requirements of the business component 65; a “duplication” shortfall is present when multiple business solutions 52 that provide overlapping functionality are present for a particular business component 64; and an “overextension” shortfall is present when a single business solution 52 provides functionality for multiple business components 64, thereby being stretched beyond its capabilities. Each type of shortfall can be addressed using a different solution: a gap shortfall can be addressed by adding a new business solution 52; a deficiency shortfall can be addressed by replacing and/or enhancing the business solution 52; a duplication shortfall can be addressed by consolidating business solutions 52; and an overextension shortfall can be addressed by splitting the business solution 52.

To this extent, solution system 32 (FIG. 1) can obtain a set of potential business solutions based on the set of business components 64. In particular, solution system 32 can select the set of potential business solutions from a set of all business solutions offered by provider 16 (FIG. 1). Each potential business solution can be selected based on its ability to address one or more of the set of shortfalls identified in component business map 62. Subsequently, the user can select the set of business solutions 52 from the potential business solutions for inclusion in business engagement 50 (FIG. 1).

Returning to FIGS. 1 and 2, in step S2, type selection system 34 can obtain one of a plurality of engagement types for each business solution 52 based on a business goal for the corresponding business solution 52. Client 18 may have one or more of various business goals for each business solution 52. For example, client 18 may desire business solution 52 in order to add new business capabilities, improve existing business capabilities (e.g., improve consistency and/or performance), and/or the like. Based on the business goal(s) for client 18, one of a plurality of engagement types can be obtained.

Each engagement type can reflect the relative importance of one or more attributes of business solution 52 based on the business goal(s) for client 18. To this extent, type selection system 34 could obtain at least one business goal from client 18 for each business solution 52 and map the business goal(s) to a corresponding engagement type. An illustrative set of engagement types can include, for example: a consistency engagement type, which indicates that client 18 desires a consistent quality for business solution 52 (e.g., a consistent delivery of services); an enhancement engagement type, which indicates that client 18 desires business solution 52 to enhance one or more attributes (e.g., productivity) of its business; and a transformation engagement type, which indicates that client 18 desires business solution 52 to implement a new business area.

In step S3, pricing model system 36 can obtain a client risk preference level for each business solution 52 in business engagement 50. A user, such as client 18, can provide an individual client risk preference level for each business solution 52, provide a single client risk preference level for business engagement 50, and/or provide a client risk preference level for a set of related business solutions 52. In any event, the client risk preference level can be based on any of numerous considerations for client 18. For example, client 18 may have a limited budget in which to implement business solution(s) 52. In this case, client 18 may desire to take on an increased risk in order to lower initial payments to provider 16.

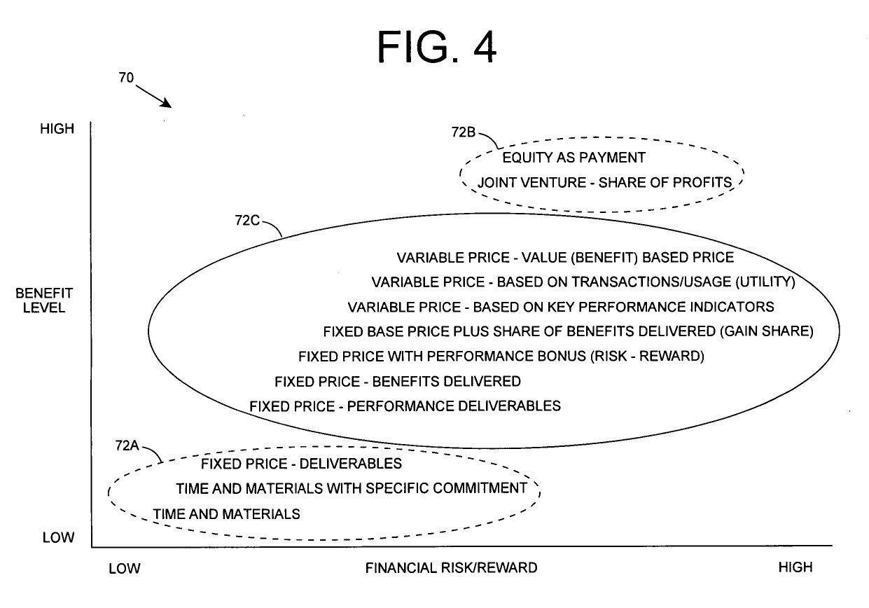

In step S4, pricing model system 36 can select one of a plurality of pricing models 54 (FIG. 1) for each business solution 52. FIG. 4 shows a graph 70 of an illustrative set of pricing models 54 that shows the relative benefit level versus financial risk/reward for each pricing model 54 according to an embodiment of the invention. Referring to FIGS. 1 and 4, pricing models 54 are shown in three groups 72A-C. Group 72A comprises an illustrative set of traditional pricing models 54 that are based on a fixed cost for client 18, frequently paid as a lump sum. In contrast, group 72B comprises an illustrative set of venturing pricing models in which provider 16 and client 18 become business partners, e.g., through the formation of a joint venture or the acquisition of equity in client 18 by provider 16. The various illustrative pricing models 54 in group 72C comprise risk/gain sharing pricing models, which assign some risk for the business solution 52 to client 18 and/or some reward for the business solution 52 to provider 16. In this manner, the interests of provider 16 and client 18 with respect to business solution 52 become increasingly more aligned as the pricing models 54 move closer to group 72B. It is understood that groups 72A-C and the pricing models 54 shown therein are only illustrative. To this extent, the invention can be applied to a different configuration of pricing models 54 that includes a different amount of groups 72A-C and/or each group 72A-C can include more or fewer pricing models 54. Further, it is understood that possible pricing models 54 can be removed, added and/or modified dynamically by a user.

In any event, each pricing model 54 can have a corresponding pricing structure. Within group 72C, some business solutions 52 have a fixed price pricing structure, while some business solutions 52 have a variable price pricing structure. In a fixed price pricing structure, an amount paid by client 18 is generally fixed in advance and the payment is provided to provider 16 when provider 16 meets certain goals, e.g., performance deliverables, benefits delivered, and/or the like. A fixed price pricing structure also may include a performance bonus, share of benefits, and/or the like based on the results of business solution 52.

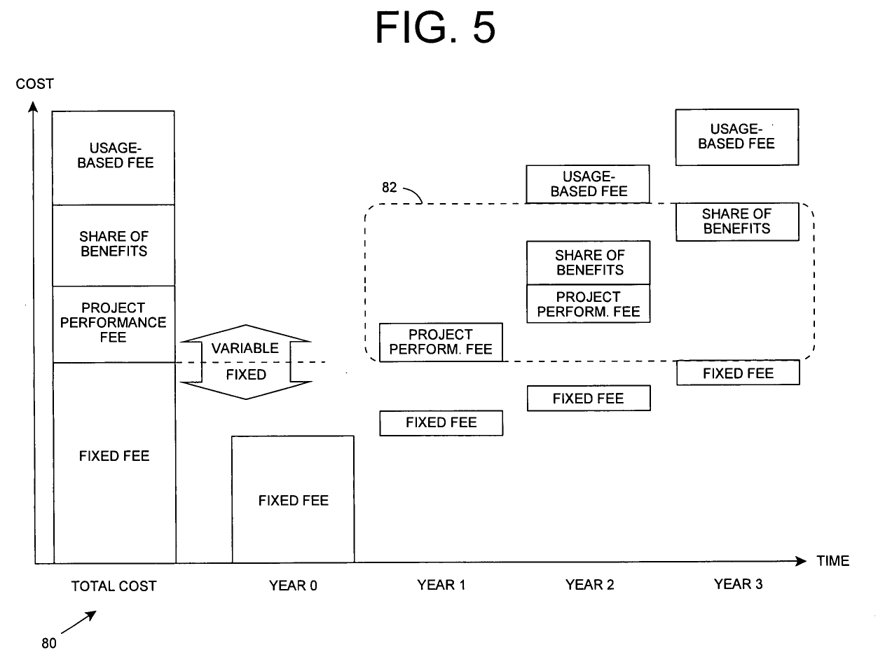

In a variable price pricing structure, the cost of business solution 52 and/or payments by client 18 can be partially or entirely based on a delivery schedule for business solution 52, a benefit provided by business solution 52, an amount that client 18 uses business solution 52, and/or the like. To this extent, FIG. 5 shows an illustrative value-based pricing structure 80 according to an embodiment of the invention. As shown, the total cost for business solution 52 (FIG. 1) includes a fixed fee component as well as several variable components. In particular, the variable components are shown including: a project performance fee which is linked to provider 16 (FIG. 1) meeting project delivery schedules; a share of benefits component, which is linked to business solution 52 exceeding a target benefit, such as a target cost savings; and a usage-based fee, which is linked to an amount that client 18 (FIG. 1) uses business solution 52. The payments made by client 18 are shown divided over an illustrative series of years (Year 0 through Year 3). In the illustrative value-based pricing structure 80, each year includes a particular fixed fee payment, which is largest in Year 0, with all years after Year 0 including some variable pricing component. Variable pricing components within area 82 comprise pricing components in which benefit outcomes and outcome payments can be determined from a business case made for implementing business solution 52 and the benefits realized by business solution 52. However, it is understood that value-based pricing structure 80 is only illustrative of numerous pricing structures that can be used by the invention described herein.

Returning to FIGS. 1 and 2, pricing model system 36 can select pricing model 54 based on the engagement type and the client risk preference level for the corresponding business solution 52. For example, for an enhancement engagement type, a pricing model 54 based on the realized improvement to client 18 can be used. In this case, for a client having a lower risk preference level, a fixed price pricing model with a performance bonus could be used. For a client having a higher risk preference level, a variable price pricing model based on the value/benefit provided by business solution 52 could be used.

In addition to the engagement type and the client risk preference level, pricing model system 36 can use one or more additional considerations in selecting an appropriate pricing model 54. To this extent, as shown in step S3, pricing model system 36 also can obtain a provider risk preference level for each business solution 52 in business engagement 50. A user, such as provider 16, can provide an individual provider risk preference level for each business solution 52, provide a single provider risk preference level for business engagement 50, and/or provide a provider risk preference level for a set of related business solutions 52. In any event, the provider risk preference level can be based on any of numerous considerations for provider 16. For example, provider 16 may desire a predictable payment for implementing business solution(s) 52. In this case, provider 16 may not desire to share risk with client 18 in exchange for lower initial payments.

Further, in step S5, pricing model system 36 can obtain a business value for each business solution(s) 52. In this case, pricing model system 36 also can consider the corresponding business value when selecting an appropriate pricing model 54 in step S4. In one embodiment, business value of a business solution 52 is determined using the invention described in the co-owned and co-pending U.S. patent application Ser. No. 11/200,847, filed on Aug. 10, 2005, and entitled “Business Solution Evaluation” and co-owned and co-pending U.S. patent application Ser. No. 11/200,727, filed on Aug. 10, 2005, and entitled “Value Model”, both of which were previously incorporated herein by reference. To this extent, pricing model system 36 and/or another system can obtain a solution risk for business solution 52, which corresponds to a probability that the corresponding business solution 52 will be successfully implemented, and a value model for business solution 52, which calculates the business value for business solution 52 using the value model and the solution risk.

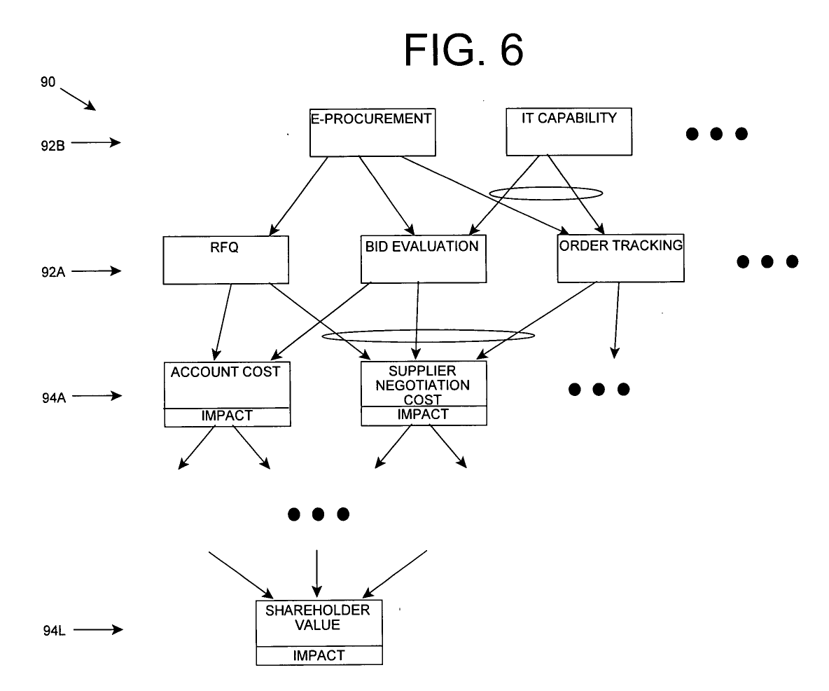

For example, FIG. 6 shows an illustrative value model 90 according to an embodiment of the invention. Value model 90 includes one or more enterprise levels 92A-B, each of which includes one or more enterprise function nodes. Each enterprise level 92A-B can comprise enterprise function nodes that represent a particular type of enterprise function (e.g., a business activity, an information technology capability, and/or the like). Further, value model 90 includes one or more driver levels 94A-L, each of which includes one or more driver metric nodes.

In value model 90, an enterprise function node in one enterprise level, such as enterprise level 92A, is connected to another enterprise function node in another enterprise level, such as enterprise level 92B, when the business activity represented by the first enterprise function node (e.g., RFQ) is affected by a change in/implementation of the business activity represented by the second enterprise function node (e.g., e-procurement). Similarly, a driver metric node in one driver level, such as driver level 94L, is connected to another driver metric node in another driver level, such as driver level 94A, when the performance/financial metric represented by the first driver metric node (e.g., shareholder value) is affected by a change in the performance metric represented by the second driver metric node (e.g., account cost). Further, a driver metric node is connected to an enterprise function node when the performance/financial metric represented by the driver metric node (e.g., account cost) is affected by a change in/implementation of the business activity represented by enterprise function node (e.g., RFQ).

In addition to defining an expected effect that a change in one node will have on another node, the relationship information in value model 90 can comprise the solution risk. The solution risk can define an uncertainty range, thereby providing a more flexible measurement of the modification. Further, the value model can include aggregate relationship data, which can be used to account for any dependencies (e.g., synergistic, cannibalistic, statistical) that may be present among different relationships. In this manner, an accurate business value, which accounts for dependencies between functions and which can be expressed as a range, a worst case, a best case, and/or the like, can be obtained using value model 90.

Returning to FIGS. 1 and 2, pricing model system 36 can select a pricing model 54 based on the engagement type, risk preference level(s), business value, and/or the like. As noted previously, pricing model system 36 can select a pricing model 54 from group 72C (FIG. 4), which includes a set of pricing models 54, each of which comprises a risk/gain sharing pricing model. Within group 72C, pricing model system 36 can further select a risk/gain sharing pricing model 54 that comprises either a fixed price pricing structure or a variable price pricing structure. While each type of risk/gain sharing pricing model (e.g., fixed price or variable price pricing structures) implement the concept of value-based pricing, these models include variables/parameters that can be determined by provider 16 and/or client 18, either individually or jointly via, for example, a negotiation process. In this manner, pricing model 54 can make the pricing process more transparent and fair, frequently leading to a win-win situation for both provider 16 and client 18.

For a fixed price pricing structure, let X denote the net business value (expressed in dollars) provided to client 18 by business solution 52. It is understood that since X comprises the net business value, any costs for business solution 52 to provider 16 (e.g., for research and development) and/or client (e.g., for implementation) have been removed from X. Further, assume X˜N(μ, σ²), that is, X follows a normal distribution with a mean of μ and a variance of σ², which can be obtained, for example, from value model 90 (FIG. 6).

Under the fixed price pricing structure, provider 16 will charge the following price:
π_{f}=c_{f}+θ_{f}μ,
where c_{f} is the cost to provider 16 and θ_{f}ε[0,1] is a parameter, e.g., θ_{f} is the portion of the expected net value created for client 18, which is charged along with the cost as part of the fixed price. While the provider's net profit is deterministic, e.g., θ_{f}μ, the net profit for client 18 is stochastic. In particular, the net profit for client 18 is equal to X−θ_{f}μ, which follows the normal distribution N((1−θ_{f})μ, σ²). As a result, the client's net profit (NP) can be specified in a probabilistic equation:
P[NP≧(1−θ_{f})μ−z_{α}σ]=α,
where z_{α} is the value such that P(Z≦z_{α})=α, for any αε[0,1], with Z˜N(0,1) being the standard normal variable. For example, z_{α}=2.33 when α=99%, z_{α}=1.65 when α=95%, etc.

Using an illustrative example, suppose the net value X is projected to be $10 million, with a standard deviation of 2; the development cost to provider 16 is $200,000; and θ_{f}=10%. In this case, provider 16 will charge a price:
π_{f}=0.2+(0.1)10=$1.2 million.

Further, the client's net profit has a mean of 10−1=$9 million, with a standard deviation of 2 (the cost of $200,000 is assumed to be netted out of X). As a result, there is a 99% chance that client 18 will have a net profit of 9−2.33(2)=$4.34 million.

For a variable price pricing structure, client 18 may pay an upfront amount π₀, plus a future amount payable at t time units after business solution 52 is implemented. The future amount can be a portion, θᵥ, of the net value that is above a certain level K. Here, both θᵥ and K are parameters that can be varied (e.g., subject to negotiation). Therefore, the total expected price charged by provider 16, discounted to the present, is:
π₀+e^{-rt}θᵥE(X−K)⁺
where r is the discount factor, such as the interest rate. For provider 16 to be willing to accept the variable price pricing structure (as opposed to the fixed price pricing structure discussed herein), then:
π₀+e^{-rt}θᵥE(X−K)⁺−cᵥ≧π_{f},
where cᵥ is the cost to provider 16 that is beyond c_{f}, e.g., additional expenses to implement the variable price pricing structure, such as monitoring the performance of business solution 52 after implementation.

Assuming that the upfront payment will at least cover the provider's costs, e.g., π₀>c_{f}+cᵥ, then the net profit for provider 16 has a deterministic component: π₀−c_{f}−cᵥ, and a stochastic component: the profit-sharing amount payable at t. The stochastic component can be denoted as Π:=θᵥ(X−K)⁺ and will follow a normal distribution N(θᵥ(μ−K), (θᵥσ)²), truncated at zero. Specifically,

$$P ( Π = 0 ) = Φ ( \frac{K - μ}{σ} ) , P ( Π \geq x ) = Φ ( \frac{x / {θ}_{v} + K - μ}{σ} ) , x > 0 ,$$

where Φ(x) denotes the distribution function of the standard normal variable, and Φ(x):=1−Φ(x). Consequently,
P[Π≧θᵥ(μ−K−z_{α}σ)]=α,
for any a such that μ−K−z_{α}σ≧0. The client's net profit can be characterized by modifying the formula for the client's net profit in the fixed fee pricing schedule to:
P[NP≧μ−π₀−z_{α}σ]=α.

Using a variable price pricing structure with the illustrative example discussed above, suppose: the additional cost to provider 16, cᵥ=$100,000, so that the total cost for provider 16 is 50% higher than the cost under the fixed scheme; the upfront charge, π₀=$800,000, K=$5 million; θᵥ=50%; t=1 year, e.g., the variable portion will be based on performance improvements in one year and paid at that point; and r=8%. In this case, client 18 keeps all of the net value created up to $5 million, but agrees to share equally with provider 16 any value above $5 million. Then, the total expected profit for provider 16, discounted to the present value, is:
π₀+e^{-rt}θᵥE(X−K)⁺=0.5+0.923(0.5)(2)(2.502)=$2.81 million,
where,

$${E ( X - K )}^{+} = {E ( μ + σ Z - K )}^{+} = σ {E ( Z - \frac{K - μ}{σ} )}^{+} .$$

The $2.81 million profit is much higher than the profit of $1 million under the fixed scheme, thereby clearly satisfying the necessary inequality. In fact, if α=95%, then
P[Π≧0.5(10−5−1.65(s)]=P[Π≧1.35]=95%.
That is, in addition to the upfront pay of $800,000, there is a 95% probability that provider 16 will receive a performance-based fee of at least $1.35 million.

Additionally, client's net return also appears to improve. In particular, client 18 will continue to have a 99% chance to obtain a net profit of at least
10−0.8−2.33(2)=$4.54 million,
which is $300,000 higher than under the fixed price pricing scheme. Further, client 18 is entitled to keep up to 5−0.8=$4.2 million of the net profit before profit-sharing any additional profit with provider 16. As a result, the variable price pricing structure results in a “win-win” situation for both provider 16 and client 18.

In any event, under a risk/gain sharing pricing model, client 18 will generally be expected to make a series of payments to provider 16 in return for the business solution 52. To this extent, in step S6, pricing model system 36 can determine a set of payments for client 18 using the selected pricing model 54. For example, for a fixed price pricing structure, pricing model system 36 can spread out the payments over a number of periods (e.g., years) during which business solution 52 is expected to be implemented. Alternatively, each payment and amount can be scheduled based on provider 16 meeting certain interim goals while implementing business solution 52. It is understood that these are only illustrative examples, and any solution can be used for determining the set of payments.

When the selected pricing model 54 comprises a variable price pricing structure, pricing model system 36 can determine an estimated set of payments for client 18 based on, for example, the anticipated time frame for implementing business solution 52 and/or the anticipated benefits client 18 will receive from business solution 52. When pricing model 54 includes both fixed fee and variable fee pricing, as shown in FIG. 5, for example, then pricing model system 36 can determine a fixed fee portion of the payments in the same manner as described for the fixed fee pricing structure, and can estimate the variable fee portion of the payments.

While business solution 52 is being implemented by provider 16, in step S7, performance system 38 (FIG. 1) can obtain performance data 56 for business solution 52. Performance data 56 can comprise any information related to the performance of business solution 52 with respect to client 18. For example, performance data 56 can comprise an implementation of certain features by provider 16, an improvement (e.g., consistency, productivity, and/or the like) to client 18 resulting from business solution 52, a new capability for client 18, and/or the like. Performance system 38 can obtain performance data 56 using any solution. For example, performance system 38 can receive performance data 56 from another system at client 18, performance system 38 can generate a user interface that enables provider 16 and/or client 18 to enter performance data, and/or the like. Additionally, performance system 38 can receive performance data 56 from a third party user, which provides benchmarking data or the like on client 18.

Performance data 56 can be used to update pricing model 54, component business map 62 (FIG. 3), value model 90 (FIG. 6), and/or the like. Further, in step S8, performance system 38 can apply a risk/gain sharing pricing model 54 to business solution 52 based on performance data 56. In particular, when performance data 56 indicates that a certain goal has been met, performance system 38 can indicate to client 18 that a payment that corresponds to the goal is due. Further, in a variable price pricing structure, performance system 38 can calculate any payment that may be due based on usage by client 18, excess benefits conferred to client 18, and/or the like, which is reflected in performance data 56.

While shown and described herein as a method and system for managing a business engagement, it is understood that the invention further provides various alternative embodiments. For example, in one embodiment, the invention provides a program product stored on a computer-readable medium, which when executed, enables a computer infrastructure to manage a business engagement. To this extent, the computer-readable medium includes program code, such as engagement system 30 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), as a data signal traveling over a network (e.g., during a wired/wireless electronic distribution of the program product), and/or the like.

In another embodiment, the invention provides a method of generating a system for managing a business engagement. In this case, a computer infrastructure, such as computer infrastructure 12 (FIG. 1), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising, and/or fee basis. That is, a service provider, such as a Solutions Integrator, could offer to manage a business engagement as described herein. In this case, the service provider can manage (e.g., create, maintain, support, etc.) a computer infrastructure, such as computer infrastructure 12 (FIG. 1), that performs the process described herein for one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a business engagement between a provider and a client, the method comprising:
obtaining a business solution included in the business engagement;
obtaining a client risk preference level for the business solution;
obtaining one of a plurality of engagement types for the business solution based on a business goal for the business solution; and
selecting one of a plurality of pricing models for the business solution based on the engagement type and the client risk preference level.

2. The method of claim 1, wherein the obtaining a business solution includes:
obtaining a business pain point;
obtaining a set of business components based on the business pain point;
obtaining a set of potential business solutions based on the set of business components; and
selecting the business solution from the set of potential business solutions.

3. The method of claim 1, further comprising:
obtaining a solution risk for the business solution;
obtaining a value model for the business solution; and
obtaining a business value for the business solution based on the value model and the solution risk, wherein the selecting is further based on the business value.

4. The method of claim 1, wherein the selected pricing model comprises a risk/gain sharing pricing model.

5. The method of claim 4, further comprising obtaining performance data for the business solution.

6. The method of claim 5, further comprising applying the risk/gain sharing pricing model to the business solution based on performance data.

7. The method of claim 4, further comprising selecting one of a fixed price pricing structure and a variable price pricing structure.

8. The method of claim 1, further comprising determining a set of payments for the client using the selected pricing model.

9. A system for managing a business engagement between a provider and a client, the system comprising:
a system for obtaining a business solution included in the business engagement;
a system for obtaining a client risk preference level for the business solution;
a system for obtaining one of a plurality of engagement types for the business solution based on a business goal for the business solution; and
a system for selecting one of a plurality of pricing models for the business solution based on the engagement type and the client risk preference level.

10. The system of claim 9, wherein the system for obtaining a business solution includes:
a system for obtaining a business pain point;
a system for obtaining a set of business components based on the business pain point;
a system for obtaining a set of potential business solutions based on the set of business components; and
a system for selecting the business solution from the set of potential business solutions.

11. The system of claim 9, further comprising:
a system for obtaining a solution risk for the business solution;
a system for obtaining a value model for the business solution; and
a system for obtaining a business value for the business solution based on the value model and the solution risk, wherein the system for selecting further bases a selection on the business value.

12. The system of claim 9, further comprising a system for obtaining performance data for the business solution when the pricing model comprises a risk/gain sharing pricing model.

13. The system of claim 12, further comprising a system for applying the risk/gain sharing pricing model to the business solution based on performance data.

14. The system of claim 12, further comprising a system for selecting one of a fixed price pricing structure and a variable price pricing structure.

15. The system of claim 9, further comprising a system for determining a set of payments for the client using the selected pricing model.

16. A program product stored on a computer-readable medium, which when executed, enables a computer infrastructure to manage a business engagement between a provider and a client, the program product comprising computer program code for enabling the computer infrastructure to:
obtain a business solution included in the business engagement;
obtain a client risk preference level for the business solution;
obtain one of a plurality of engagement types for the business solution based on a business goal for the business solution; and
select one of a plurality of pricing models for the business solution based on the engagement type and the client risk preference level.

17. The program product of claim 16, wherein the computer program code for enabling the computer infrastructure to obtain a business solution enables the computer infrastructure to:
obtain a business pain point;
obtain a set of business components based on the business pain point;
obtain a set of potential business solutions based on the set of business components; and
select the business solution from the set of potential business solutions.

18. The program product of claim 16, further comprising computer program code for enabling the computer infrastructure to:
obtain a solution risk for the business solution;
obtain a value model for the business solution; and
obtain a business value for the business solution based on the value model and the solution risk, wherein the computer program code for enabling the computer infrastructure to select further bases a selection on the business value.

19. The program product of claim 16, further comprising computer program code for enabling the computer infrastructure to obtain performance data for the business solution when the pricing model comprises a risk/gain sharing pricing model.

20. The program product of claim 19, further comprising computer program code for enabling the computer infrastructure to apply the risk/gain sharing pricing model to the business solution based on performance data.

21. The program product of claim 19, further comprising computer program code for enabling the computer infrastructure to select one of a fixed price pricing structure and a variable price pricing structure.

22. The program product of claim 16, further comprising computer program code for enabling the computer infrastructure to determine a set of payments for the client using the selected pricing model.

23. A method of generating a system for managing a business engagement between a provider and a client, the method comprising:
providing a computer infrastructure operable to:
obtain a business solution included in the business engagement;
obtain a client risk preference level for the business solution;
obtain one of a plurality of engagement types for the business solution based on a business goal for the business solution; and
select one of a plurality of pricing models for the business solution based on the engagement type and the client risk preference level.
